(19) United States
(12) Patent Application Publication
(10) Pub. No.: US 2005/0117353 A1
(43) Pub. Date: Jun. 2, 2005

(54) Protective grid for work light

(75) Inventor: Albert Stekelenburg, Taipei (TW)

Correspondence Address: BRUCE H. TROXELL, SUITE 1404, 5205 LEESBURG PIKE, FALLS CHURCH, VA, 22041, US

(73) Assignee: All-Line Inc.

(21) Appl. No.: 10/722,605

(22) Filed: Nov. 28, 2003

(51) Int. Cl. F21V 21/00; F21V 15/00

(52) U.S. Cl. 362/376; 362/431

(57) ABSTRACT

A protective grid of work light which adopted in the rear portion of main body of said halogen work light, said protective grid is spaced with rear portion of said main body; said main body can be adopted to the fixed lamp frame as well as the portable way.

### FIELD OF THE INVENTION

The present invention is relating to the lighting device, especially to the work lamp with grid adopted on the rear side thereof.

### BACKGROUND OF THE INVENTION

Work lamp or normally known as work light, especially the lighting device having halogen bulb or tube, is a conventional lighting instrument widely used in indoor as well as outdoor, mainly for in work place or plant, and large space lighting. The reasons of using halogen light bulb or tube are that it can produce stronger light and covered by the stiff outer shell.

FIG. 1 shows the conventional halogen work light, it comprising a main body A, on front side; a lamp, such as halogen bulb or B adopted inside said main body A, and the back (rear) side C of said main body A, provided a wire box D which the electrical wires inside.

However, on the rear side C of the above-mentioned main body A always causes the heat. Under the high temperature, to those people who repairing, maintenance, as well as working nearby, the risk is always existed.

In certain working places, always use the portable halogen work light as lighting device. But, due to it always hit by other articles, therefore, in order to prevent the harm caused by hit, the improvement normally is to increase the thickness of the shell of rear portion or whole lighting device.

Up to now, the rear side of all halogen work light sold in marketplace is bare without any shielding, therefore, it is worthy for us to improve it.

### SUMMARY OF THE INVENTION

The main object and purpose of the present invention is to provide a protective grid on the rear side of halogen work light.

Said protective grid including the connecting plate which can be connected to the main body and plurality of grid rods.

The protective area of said protective grid is in such a way that the wire box can be still bared to enable for installment, repair as well as maintenance.

Said protective grid can be composed by vertical rods, horizontal rods, slope rods, netting rods and as the like.

### BRIEF DESCRIPTION OF THE DRAWINGS

FIG. 1 is the prospective view of the conventional halogen light.

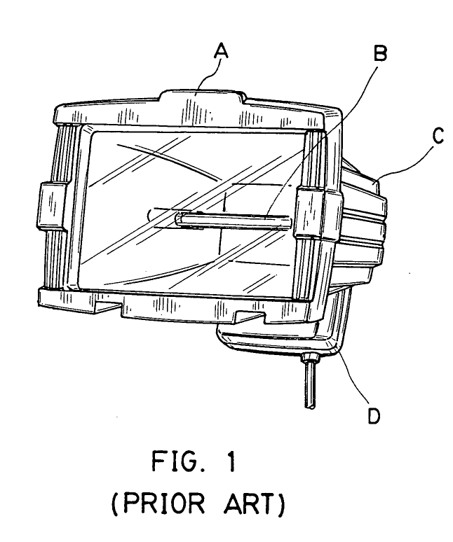

FIG. 2 is the rear prospective view of the main body of the present invention.

FIG. 3 is the prospective view of the main body and protective grid of the present invention.

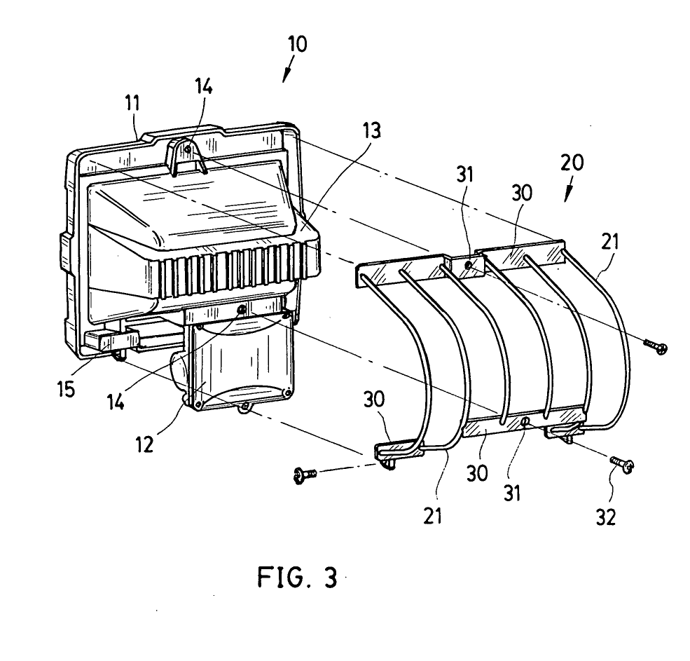

### DETAILED DESCRIPTION OF PREFERRED EMBODIMENTS

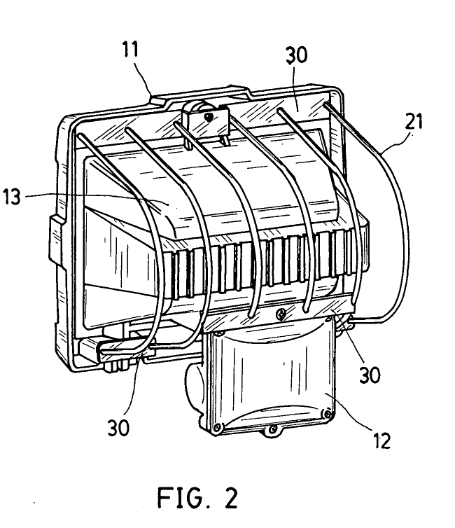

Refer to FIGS. 2 & 3, the construction of the present invention is adopt a protective grid on the rear side of main body 10, said protective grid comprising grid body 20 and connecting plate 30 connected respectively.

Main body 10 is conventional structure and normally comprising a lamp body 11 and a wire box 12 and lamp body 11 further including a rear portion 13.

In the embodiment of the present invention, proper place around the rear portion 13, provides the connecting member for adopting said protective grid, such as screwing holes 14 and protrusion plate 15.

Grid body 20 constructed as to cover the rear portion 13 of main body 10. The configuration can be by parallel grids rods, netting or crossed by horizontal and vertical rods. Said rods 21 can be formed by bending and their both ends fixed to the connecting plate 30.

Said connecting plate 30 is the structure which can be connected to the rear portion 13 of said lamp body 11. As shown in drawings, connecting plate 30 providing the hole 31 which corresponding to screwing holes respectively, it can be but not limited to use screw 32 to connect with said lamp body 11.

The way and structure of connecting the grid body 20 to the rear portion 13 of said lamp body is limited to the above-mentioned embodiment.

Refer to drawings, between protective grid and rear portion 13, there are plurality of gap formed by rods to prevent hit, touch or unnecessary contact to said rear portion 13. Meanwhile, by adopting the protective grid in rear portion 13, under the protective grid, there is still an open space which to avoid influence to the wire box 12 as well as relating external connecting devices.

Due to versatile shapes of lamp body 11, therefore, the protective grid can be designed to comply with the rear portion of lamp body respectively.

Said main body 10 of work light can be adopted and fixed to the lamp frame as well as adopted as the portable way.

The embodiment disclosed in the specification is only one of the examples. Any minor change or modification derived from the inventive concept of the present invention will still fall within the scope of the present invention.

1. A protective grid of work light which adopted in the rear portion of main body of said halogen work light, said protective grid is spaced with rear portion of said main body.

2. The protective grid of work light as claimed in claim 1, wherein said protective grid is constructed by plurality of grid rods and both ends of said grid rods fixed to the connecting plates.

3. The protective grid as claimed in claim 2, said grid rods are arranged by vertical in parallel, horizontal in parallel, crossed vertical and horizontal as well as crossed by slope rods.
